(19) United States
(12) Patent Application Publication
(10) Pub. No.: US 2019/0325178 A1
(43) Pub. Date: Oct. 24, 2019

(54) MONITORING APPARATUS AND METHOD FOR CASINO CHIP MANAGEMENT

(71) Applicant: Clonix Co., Ltd., Seongnam-si (KR)

(72) Inventor: Seung Lee Nam, Suwon-si (KR)

(21) Appl. No.: 16/388,873

(22) Filed: Apr. 19, 2019

(30) Foreign Application Priority Data
Apr. 24, 2018 (KR) 10-2018-0047161

(51) Int. Cl. G06K 7/10; G06F 16/23; G06K 19/077

(52) U.S. Cl. CPC G06K 7/10366; G06K 19/07758; G06F 16/2379

(57) ABSTRACT

A monitoring apparatus for casino chip management includes: an information detecting part configured to detect an RFID value of a subject casino chip; a storage configured to store a total list DB and an unstoring list DB; a matching process part configured to compare the RFID value detected by the information detecting part and at least one list DB of the list DBs; a database managing part configured to update the list DBs based on a result of comparison of the matching process part; and an alarming part.

### CROSS-REFERENCE TO RELATED APPLICATIONS

This application is based on and claims priority under 35 U.S.C. § 119 to Korean Patent Application No. 10-2018-0047161, filed on Apr. 24, 2018, in the Korean Intellectual Property Office, the disclosure of which is herein incorporated by reference in its entirety.

### BACKGROUND

### 1. Field

The present disclosure relates to a monitoring apparatus and method for managing casino chips which are carried in to or out from a currency exchange office, and for detecting fake chips rapidly and exactly.

### 2. Description of the Related Art

Technology known as radio frequency identification (RFID) refers to technology for reading data stored in a tag contactlessly by using radio frequency, and is typically configured by an RFID tag and an RFID reader.

The RFID tag (hereinafter, may be referred to as a “tag”) has data such as an identification code stored therein, and transmits data stored therein to the RFID reader (hereinafter, may be referred to as a “reader”) upon receiving a request from the reader.

The tag may be called a transponder, and is typically configured to include a transponder chip formed with a semiconductor, and an antenna. Herein, the transponder chip is an integrated circuit (IC) chip which is able to store and modulate data, and the antenna is functionally connected with the transponder chip.

The tag may be divided into an active tag and a passive tag. The active tag has a battery embedded therein and transmits data to the reader by using power stored in the battery, whereas the passive tag does not have a battery, and receives necessary power from the reader and transmits data to the reader by using the power received from the reader.

Data such as an identification code is memorized in the transponder chip included in the RFID, and the tag transmits data stored in the transponder chip upon receiving a request from an external reader. The RFID technology is used in various fields such as logistics management, book management, payment, etc. For example, RFID tags may be attached to products in a large shopping mall, and an RFID reader may read data stored in the tags with the products being stacked in a cart, thereby identifying types of all products stacked in the cart and calculating the total price.

In another example, the RFID technology may be used in casino chips to calculate an amount of betting or to prevent theft of casino chips.

U.S. Pat. No. 6,021,949, Korean Patent Laid-Open Publication No. 2007-98227, Japanese Patent Laid-Open Publication No. 2004-102953, and Korean Patent No. 346859 disclose technology of RFID function for casino chips. According to related-art technologies, passive tags are embedded in casino chips. Korean Patent Laid-Open Publication No. 2005-11592 discloses technology having active tags embedded in casino chips.

In the above-described related-art technologies, a tag formed of an antenna and a transponder chip is installed in a casino chip formed in a coin shape. Herein, the antenna is formed to have substantially the same center as the casino chip of the coin shape.

For example, the tag embedded in the casino chip stores data which is formed of a 12 or 16-digit hexa value, and such data includes a unique identification (UID), a value indicating a manufacturer (hereinafter, referred to as a “manufacturer value”), and a value indicating a type (amount) of a chip (hereinafter, referred to as a “chip type value”).

As a related-art method for determining authenticity of a casino chip, there is a method of comparing a UID, a manufacturer value, and a chip type value of a chip stored in a tag embedded in the casino chip, and a database (DB) in which information of all casino chips is recorded. However, such a related-art method may have a problem that it cannot detect falsification of a genuine chip when all of the UID, the manufacturer value, and the chip type value of the casino chip are fraudulently reproduced.

### SUMMARY

Various embodiments of the present disclosure provide a monitoring apparatus and method for managing casino chips which are carried in to or out from a currency exchange office, and for detecting a fake chip rapidly and exactly.

Various embodiments of the present disclosure also provide a monitoring apparatus and method for determining a fake chip when many chips having UIDs are detected in a currency exchange office.

According to an embodiment, a monitoring apparatus for casino chip management includes: an RFID reader configured to read an RFID tag of a subject casino chip which is being carried in to or carried out from a currency exchange office; an information detecting part configured to detect an RFID value of the subject casino chip from data read by the RFID reader; a storage configured to store list DBs; a matching process part configured to compare the RFID value detected by the information detecting part and at least one list DB of the list DBs; a database managing part configured to update the list DBs based on a result of comparison of the matching process part; and an alarming part.

The list DBs may include a total list DB including RFID values of all casino chips which are distributed and used in the currency office exchange, and an unstoring list DB including RFID values of casino chips which are carried out from the currency exchange office.

The RFID value of the subject casino chip may include a UID of the subject casino chip.

When the result of comparison of the matching process part indicates that the subject casino chip is a fake chip, the alarming part may output an alarm signal indicating that the subject casino chip is a fake chip.

When the result of comparison of the matching process part indicates that the subject casino chip is being carried in, the database managing part may delete the RFID value of the subject casino chip from the unstoring list DB.

According to another embodiment of the present disclosure, a monitoring method for casino chip management may include: reading an RFID tag of a subject casino chip; extracting an RFID value from data read from the RFID tag; comparing the RFID value and list DBs; updating the list DBs based on a result of the comparing; and outputting an alarm indicating that the subject casino chip is a fake chip.

The list DBs may include a total list DB including RFID values of all casino chips which are distributed and used in a currency office exchange, and an unstoring list DB including RFID values of casino chips which are carried out from the currency exchange office.

The RFID value of the subject casino chip may include a UID of the subject casino chip.

The outputting the alarm may include, when the RFID value of the subject casino chip is not included in the total list DB, outputting the alarm.

The updating the list DBs may include, when the RFID value of the subject casino chip is included in the unstoring list DB, deleting the RFID value of the subject casino chip from the unstoring list DB.

According to one or more embodiments of the present disclosure, even if an RFID value embedded in a casino chip is falsified, the falsified casino chip can be detected. In addition, when it is determined that a casino chip is a fake chip, an alarm can be immediately outputted to a manager, such that the manager can take measures.

### BRIEF DESCRIPTION OF THE DRAWINGS

The above and/or other aspects of the present disclosure will be more apparent by describing certain exemplary embodiments of the present disclosure with reference to the accompanying drawings, in which:

FIGS. 1 and 2 are views to explain a monitoring apparatus for casino chip management according to an embodiment of the present disclosure; and

FIG. 3 is a flowchart to explain a monitoring method for casino chip management according to an embodiment of the present disclosure.

### DETAILED DESCRIPTION OF EMBODIMENTS

Exemplary embodiments will now be described more fully with reference to the accompanying drawings to clarify aspects, other aspects, features and advantages of the present disclosure. The exemplary embodiments may, however, be embodied in many different forms and should not be construed as limited to the exemplary embodiments set forth herein. Rather, the exemplary embodiments are provided so that this disclosure will be thorough and complete, and will fully convey the scope of the present disclosure to those of ordinary skill in the art.

If the terms such as ‘first’ and ‘second’ are used to describe various elements, these elements should not be limited by such terms. These terms are used for the purpose of distinguishing one element from another element only. The exemplary embodiments explained and illustrated herein include their complementary embodiments.

The terms used herein are for the purpose of describing particular exemplary embodiments only, and are not intended to be limiting. As used herein, the singular forms are intended to include the plural forms as well, unless the context clearly indicates otherwise. It will be further understood that the terms “comprise” and/or “comprising,” when used in the detailed description, do not preclude the presence or addition of one or more other elements.

### Definition of Terms

In the detailed description, the term “software” refers to technology of moving hardware in a computer, and a “program” is a representative example of “software.”

In the detailed description, the term “hardware” refers to an apparatus or device configurating a computer (for example, a central processing unit (CPU), a memory, an auxiliary storage device, an input device (for example, a keyboard, a mouse, or a touch screen), an output device (for example, a touch screen), a peripheral device, a communication device (for example, a local area network (LAN) card)).

In the detailed description, the term “step” refers to a series of processes or operations connected with one another in the time series to achieve a predetermined object, and the term “program” refers to a set of commands added to process with a computer.

In the detailed description, the term “database management system” refers to a program which stores data in a storage device such as a storage, and manages the stored data to be corrected or deleted, or manages data to be added.

In the detailed description, the term “management” refers to “reception,” “transmission,” “storage,” “correction,” and “deletion” of data. The term “part” refers to a program and/or hardware for performing a certain function.

In the detailed description, the term “computer” may refer to an apparatus provided with an operating system such as Windows, Mac, or Linux, a computer processor, a memory, application programs, a storage device (for example, a hard disk drive (HDD), a solid state drive (SSD)), and a monitor. The computer may be, for example, a desktop computer or a laptop computer, but these are merely examples, and the present disclosure is not limited to the desktop computer or the laptop computer. A mobile wireless communication device may be a smartphone, a tablet PC, or a personal digital assistant (PDA). These are merely examples and the present disclosure is not limited to the tablet PC or the PDA. In addition, a portion of the mobile wireless communication devices may be devices of the same kind, and the other portion may be devices of different kinds.

In the detailed description, the expression “computer-readable recording medium” refers to a semiconductor storage device using an integrated circuit (IC), a magnetic storage device using a magnetic recording method, and/or an optical storage device using an optical disk. In addition, the “computer-readable recording medium” may be included and installed in a computer which directly reads data from a recording medium, or may be connected with a computer wiredly or wirelessly, or through a communication network (for example, a wide area network (WAN), a metropolitan area network (MAN), a local area network (LAN), and/or a personal area network (PAN)).

In the detailed description, the term “subject casino chip” is a subject to be detected by the monitoring apparatus of the present disclosure, and for example, may refer to a casino chip which is currently carried out or carried in.

In the detailed description, the term “carry-out casino chip” refers to a chip which is moved to a place (a place which is not detected by the monitoring apparatus 100 according to an embodiment) out of a currency exchange office from among casino chips located in the currency exchange office.

In the detailed description, the term “carry-in casino chip” refers to a casino chip which is moved to the currency exchange office from among casino chips located in a place out of the currency exchange office (a place which is not detected by the monitoring apparatus 100 according to an embodiment).

In the detailed description, the term “list DB” refers to a list including UIDs of casino chips, and for example, may be a total list DB, a storing list DB, a unstoring list DB, a long term unstoring list DB, or a missing list DB.

Hereinafter, embodiments of the present disclosure will be described in detail with reference to the accompanying drawings.

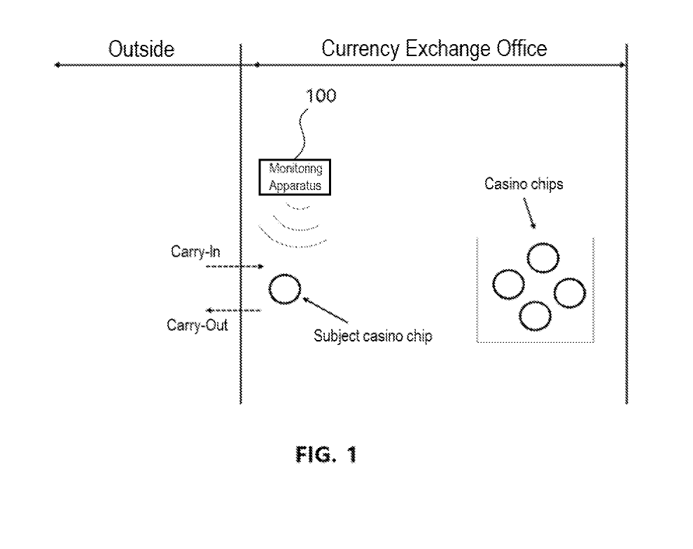

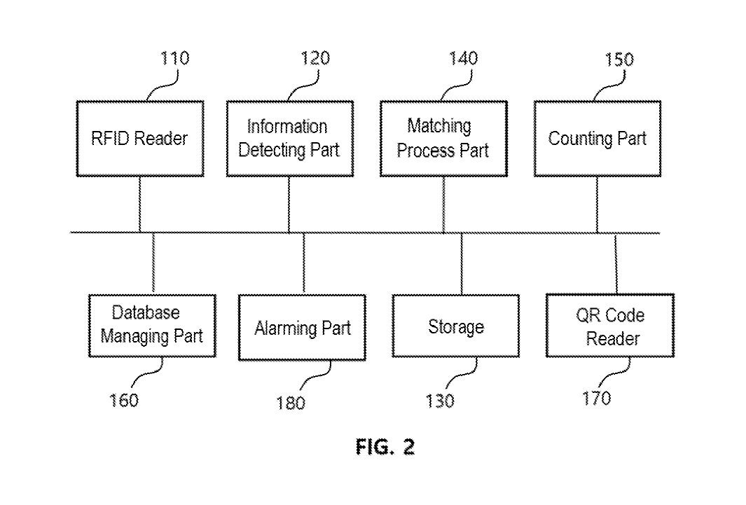

FIGS. 1 and 2 are views to explain a monitoring apparatus for casino chip management according to an embodiment of the present disclosure. The monitoring apparatus 100 for casino chip management illustrated in the drawings follows an embodiment. Elements included in the monitoring apparatus 100 are not limited to those in the embodiment of FIG. 2, and those skilled in the art may add, change, or exclude some of the elements if necessary when embodying the present disclosure.

Referring to FIGS. 1 and 2, the monitoring apparatus 100 for casino chip management according to an embodiment may include an RFID reader 110, an information detecting part 120, a storage 130, a matching process part 140, a counting part 150, a database managing part 160, and an alarming part 180. Herein, the monitoring apparatus 100 for casino chip management may further include a QR code reader 170. These elements may be directly connected with one another or may be connected with one another through a communication network. The communication network may be, for example, a WAN, a MAN, a LAN, and/or a PAN.

The monitoring apparatus 100 for casino chip management according to an embodiment may further include a computer processor (not shown) such as a CPU, a memory (not shown), and a storage device (not shown).

Herein, the storage device (not shown) may store an operating system (OS), programs for performing operations according to an embodiment, and other programs for operation of the monitoring apparatus 100. These programs may be loaded into the memory (not shown) and then may perform their own operations by using the computer processor. That is, the computer processor (not shown), the memory (not shown), the storage device (not shown), and the programs (not shown) are operatively connected to one another.

The RFID reader 110 may be, for example, a device which is configured to supply power to an RFID tag of a subject casino chip and to read data stored in the RFID tag.

The information detecting part 120 extracts an RFID value from the data read by the RFID reader 110. The information detecting part 120 may be implemented by a computer program. For example, the information detecting part 120 may be loaded into the memory (not shown) and may perform its own operation under control of the computer processor (not shown). The information detecting part 120 may be implemented by hardware formed of one or more semiconductor chips.

The matching process part 140 may be implemented by a computer program, for example. For example, the matching process part 140 may be loaded into the memory (not shown) and may perform its own operation under control of the computer processor (not shown). The matching process part 140 may be implemented by hardware formed of one or more semiconductor chips.

The counting part 150 may be implemented by a computer program, for example. For example, the counting part 150 may be loaded into the memory (not shown) and may perform its own operation under control of the computer processor (not shown). The counting part 150 may be implemented by hardware formed of one or more semiconductor chips.

The storage 130 may be a storage device which is separately provided from the storage device (not shown) included in the monitoring apparatus 100, or may be a storage device which is included in the monitoring apparatus 100.

The database managing part 160 may be implemented by a computer program, for example. For example, the database managing part 160 may be loaded into the memory (not shown) and may perform its own operation under control of the computer processor (not shown).

The alarming part 180 may output an alarm signal indicating that the subject casino chip is a fake chip. Such an alarm signal may be a signal in a form (visible form or an audible form) that can be recognized by a manager.

The alarming part 180 may use a result of comparison of the matching process part 140, and performs an operation according to the result of comparison. For example, when the result of comparison of the matching process part 150 (that is, an output) indicates that the subject casino chip is a fake chip, the alarming part 180 may output an alarm signal such as a beeping sound.

The monitoring apparatus 100 for casino chip management according to an embodiment is located in a currency exchange office. According to an embodiment, all of the elements constituting the monitoring apparatus 100 may be located in the currency exchange office. According to an alternative embodiment, some of the elements constituting the monitoring apparatus 100 may be located in a place other than the currency exchange office. For example, the RFID reader 110 and the QR code reader 170 may be located in the currency exchange office, and the database managing part 160 and the storage 130 may be located in other places connected via a communication network, and the other elements (the information detecting part 120, the matching process part 140, the counting part 150) may be located in the currency exchange office or other places. In addition, elements which are not illustrated in FIG. 1 may be located in places other than the currency exchange office.

The RFID reader 110 may read RFID tags embedded in all subject casino chips which are carried in to or carried out from the currency exchange office in real time.

According to an embodiment, the RFID reader 110 may be installed in a position where the RFID reader 100 can read the RIFD tags embedded in the subject casino chips carried in to or carried out from the currency exchange office.

In the casino chips used in the embodiments, RFID tags operating mutually with the RFID reader 110 are embedded.

The RFID tag of the subject casino chip may store data which is formed of a 12 or 16-digit hexa data, and the data includes a unique identification (UID) uniquely assigned to a tag to identify the tag (hereinafter, referred to as a “UID”), a value indicating a manufacturer (hereinafter, referred to as a “manufacturer value”), and a value indicating a type (amount) of a chip (hereinafter, referred to as a “chip type value”).

Data extracted from the data stored in the RFID tag, such as the UID, the manufacturer value, and/or the chip type value, will be referred to as an “RFID value” in the detailed description.

The information detecting part 120 detects an RFID value such as a UID, a manufacturer value, and a chip type value from the data read by the RFID reader 110. Preferably, the information detecting part 120 may necessarily detect the UID, and may detect at least one of the manufacturer value and the chip type value as an option.

According to an embodiment, the values detected by the information detecting part 120 may be provided to the matching process part 140, the counting part 150, and the database managing part 160.

The storage 130 may store a total list DB, an unstoring list DB, and a storing list DB.

The storage 130 may be a semiconductor storage device using an IC, a magnetic storage device using a magnetic recording method, and/or an optical storage device using an optical disk. In addition, the storage 130 may be a storage device such as an SSD or an HDD.

The total list DB is a database that includes respective RFID values stored in all casino chips distributed and used in the currency exchange office. The total list DB includes all of the RFID values of the casino chips carried out from the currency exchange office and of the casino chips located in the currency exchange office.

The total list DB may further include data indicating a current state of a casino chip. For example, the total list DB may further include data indicating whether a casino chip is currently in a carry-out state or is in a holding state. Herein, the “carry-out” state refers to a state in which the casino chip is not in the currency exchange office. The “holding” state refers to a state in which the casino chip is in the currency exchange office. The total list DB may further include a time at which the casino chip is carried out when the casino chip is in the carry-out state.

The total list DB may further include a time at which a casino chip is carried out and a time at which the casino chip is carried in when the casino chip is carried in after being carried out.

The unstoring list DB is a database including RFID values embedded in all casino chips carried out from the currency exchange office. The RFID values included in the unstoring list DB are included in the total list DB, and are related to casino chips which are not currently in the currency exchange office.

The unstoring list DB may further include a time at which a casino chip is carried out.

The storing list DB is a database including RFID values embedded in all casino chips which are currently located in the currency exchange office. The RFID values included in the storing list DB are included in the total list DB, and are related to casino chips which are currently located in the currency exchange office.

The storing list DB may further include a time at which a casino chip is carried in to the currency exchange office.

In addition, the storage 130 may additionally store a long-term unstoring list DB. The long-term unstoring list DB is a database which includes RFID values of casino chips that are not carried in to the currency exchange office over a predetermined period (hereinafter, referred to as a “first set period”) from among the casino chips carried out to the outside. The first set period may be a period starting from the time at which a casino chip is carried out to the outside from the currency exchange office.

In addition, the storage 130 may additionally store a missing list DB. The missing list DB is a database which includes RFID values of casino chips that are not carried in over a predetermined period (hereinafter, referred to as a “second set period”) from among the casino chips carried out to the outside. The second set period may be a period that starts from the time at which a casino chip is carried out to the outside. The second set period is typically longer than the first set period.

According to an embodiment, each of the above-described list DBs includes a field and a record. Herein, the field includes the UID, manufacturer value, and the chip type value, and a key field may be the UID.

The matching process part 140 may perform one or more of the following operations upon receiving the RFID values (hereinafter, referred to as “subject RFID values”) detected by the information detecting part 120 from the subject casino chips:

comparing the “subject RFID value” and the total list DB;

comparing the “subject RFID value” and the unstoring list DB; and

comparing the “subject RFID value and the “storing list DB.”

The order of these operations may be determined according to the situation when a person working in the technical field to which the present disclosure belongs embodies the present disclosure.

### Embodiment 1

In embodiment 1, the total list DB and the unstoring list DB are used, and the storing list DB is not used.

When the ‘subject RFID value” is not included in the total list DB as a result of comparing the “subject RFID value” and the total list DB, the matching process part 140 may output a value (hereinafter, a “result”) indicating that the subject casino chip is a fake chip.

In addition, when the “subject RFID value” is included in the unstoring list DB as a result of comparing the “subject RFID value” and the unstoring list DB, the matching process part 140 may output a result indicating that the subject casino chip is a genuine chip and is being carried in.

In addition, when the “subject RFID value” is not included in the unstoring list DB, but is included in the total list DB, the matching process part 140 may output a result indicating that the subject casino chip is a genuine chip and is being carried out.

The output value of the matching process part 150 may be provided to the database managing part 160 and the alarming part 180.

When a value indicating that the subject casino chip is a fake ship is outputted from the matching process part 150, the alarming part 180 outputs an alarm signal (for example, a sound or a visual display) indicating that the subject casino chip is a fake chip.

When a value indicating that the subject casino chip is being carried in is outputted from the matching process part 140, the database managing part 160 deletes the “subject RFID value” of the subject casino chip from the unstoring list DB.

When a value indicating that the subject casino chip is being carried out is outputted from the matching process part 140, the database managing part 160 adds the “subject RFID value” of the subject casino chip to the unstoring list DB.

### Embodiments 2

In embodiment 2, the total list DB, the unstoring list DB, and the storing list DB are used.

When the “subject RFID value” is not included in the total list DB as a result of comparing the “subject RFID value” and the total list DB, the matching process part 140 may output a result indicating that the subject casino chip is a fake chip.

In addition, when the “subject RFID value” is included in the unstoring list DB as a result of the “subject RFID value” and the unstoring list DB, the matching process part 140 may output a result indicating that the subject casino chip is a genuine chip and is being carried in.

In addition, when the “subject RFID value” is included in the storing list DB as a result of comparing the “subject RFID value” and the storing list DB, the matching process part 140 may output a result indicating that the subject casino chip is a genuine chip and is being carried out.

In addition, when the “subject RFID value” is not included in the unstoring list DB, but is included in the total list DB, the matching process part 140 may output a result indicating that the subject casino chip is a genuine chip and is being carried out.

In addition, when the “subject RFID value” is not included in the storing list DB, but is included in the total list DB, the matching process part 140 may output a result indicating that the subject casino chip is a genuine chip and is being carried in.

The output of the matching process part 140 may be provided to the database managing part 160 and the alarming part 180.

When a value indicating that the subject casino chip is a fake chip is outputted from the matching process part 140, the alarming part 180 outputs an alarm (for example, a sound or a visual display) indicating that the subject casino chip is a fake chip.

When a value indicating that the subject casino chip is being carried in is outputted from the matching process part 140, the database managing part 160 may delete the “subject RFID value” of the subject casino chip from the unstoring list DB, and may add the subject RFID value to the storing list DB.

When a value indicating that the subject casino chip is being carried out is outputted from the matching process part 140, the database managing part 160 may add the “subject RFID value” of the subject casino chip to the unstoring list DB, and may delete the subject RFID value from the storing list DB.

The counting part 150 may count an unstoring period of a casino chip which is carried out to the outside.

When there is a casino chip (hereinafter, referred to as a “long-term no carry-in casino chip”) that is not carried in to the currency exchange office even when the first set period is elapsed from the time that the casino chip is carried out, from among the casino chips carried out to the outside, the counting part 150 may provide the RFID value of such a casino chip to the database managing part 160.

When there is a casino chip (hereinafter, referred to as a “missing casino chip”) that is not carried in to the currency exchange office over the second set period from the time that the casino chip is carried out, from among the casino chips carried out to the outside, the counting part 150 may provide the RFID value of such a casino chip the database managing part 160.

According to an embodiment, the counting part 150 may provide RFID values which exceed the first set period from among the RFID values included in the unstoring list DB to the database managing part 160, and such RFID values may be added to the long-term unstoring list DB.

In addition, the counting part 150 may provide RFID values which exceed the second set period from among the RFID values included in the unstoring list DB to the data managing part 160, and such RFID values may be added to the missing list DB. Alternatively, the counting part 150 may provide RFID values which exceed the second set period from among the RFID values included in the long-term unstoring list DB to the database managing part 160, and such RFID values may be added to the missing list DB.

The database managing part 160 may add the RFID values of the “long-term no carry-in casino chips” provided from the counting part 150 to the long-term unstoring list DB. For example, the database managing part 160 may add the RFID values of the “long-term no carry-in casino chips” to the long-term unstoring list DB which is already stored in the storage 130.

The database managing part 160 may add RFID values of the missing casino chips provided from the counting part 150 to the missing list DB. For example, the database managing part 160 may add the RFID values of the missing casino chips to the missing list DB which is already stored in the storage 130.

When it is determined that a subject casino chip is carried out from the currency exchange office, the database managing part 160 may record the RFID value of the subject casino chip on the unstoring list DB and may delete the RFID value recorded on the storing list DB.

When it is determined that a subject casino chip is carried in to the currency exchange office, the database managing part 160 may record the RFID value of the subject casino chip on the storing list DB and may delete the RFID value recorded on the unstoring list DB. When the RFID value of the carried-in casino chip is stored in the long-term unstoring list DB, the database managing part 160 may delete the RFID value of the casino chip stored in the long-term unstoring list DB.

The QR code reader 170 reads a QR code printed on the subject casino chip when it is determined that the subject casino chip is a fake chip (first determination). In this case, the QR code may be printed on the surface of the casino chip and may store UID information of the casino chip.

The QR code reader 170 may be provided in the apparatus 100 of the present disclosure or may be installed in a smartphone owned by the manager. When the QR code reader 170 is installed in the smartphone, the QR code reader 170 may be installed in the smartphone as a program and may be executed. When a camera provided in the smartphone scans the QR code, the QR code reader 170 reads UID information from the scanned QR code.

On the surface of the casino chip used in the present disclosure, the QR code having UID encrypted and included therein may be imprinted by lasers. Such a QR code may not be seen with naked eyes. The QR code imprinted on the surface of the casino chip may not be seen with naked eyes, but the QR code reader 170 may read such a QR code.

In addition, the matching process part 140 may determine whether the subject casino chip determined as a fake chip at the first determination is a fake chip by using a value of the QR code (second determination). To achieve this, the matching process part 140 may receive the QR code from the QR code reader 170 or may receive the UID included in the QR code.

The matching process part 140 may compare the UID included in the RFID value read by the RFID reader 110, detected by the information detecting part 120, and the UID read by the QR code reader 170. When both the UIDs are the same as a result of comparison, the matching process part 140 may output a value indicating that the subject casino chip is not a fake chip, and, when both the UIDs are different from each other, the matching process part 140 may output a value indicating that the subject casino chip is a fake chip. The value finally outputted by the matching process part 140 may be provided to the database managing part 160 and the alarming part 180.

That is, when the UID included in the QR code does not exist in the total list DB, the alarming part 180 may output an alarm signal indicating that the subject casino chip is a fake chip again.

Determining whether the subject casino chip is a genuine chip again by using the QR code as described above is to prevent a genuine chip from being determined as a fake chip due to a mistake of the manager or unpredictable malfunction of the apparatus 100 of the present disclosure. For example, when a casino chip is carried out to a player from the currency exchange office, the casino chip may not be exactly recorded on the unstoring list DB. In this case, the casino chip may be determined as a fake chip when being carried in.

As described above, illegal distribution of casino chips can be prevented by outputting an alarm when there are fake or abnormal casino chips.

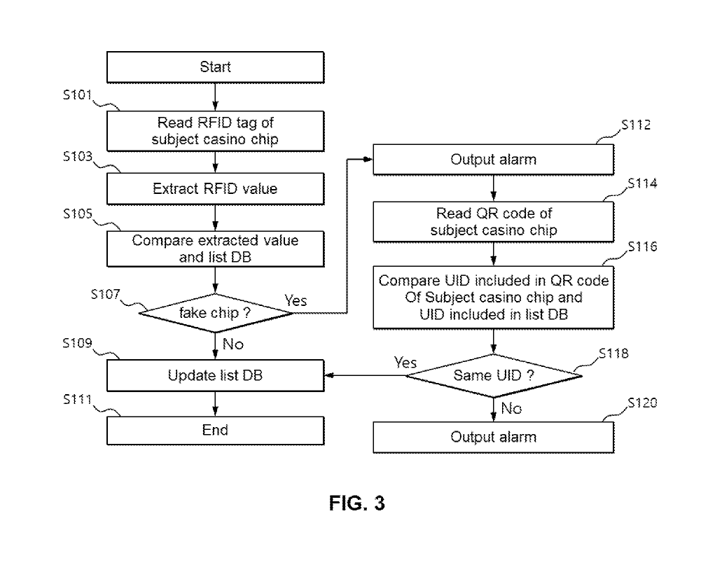

FIG. 3 is a flowchart to explain a monitoring method for casino chip management according to an embodiment. For the sake of explanation, it is assumed that the monitoring method for casino chip management according to an embodiment is applied to the monitoring apparatus 100 for casino chip management described above with reference to FIGS. 1 and 2.

Referring to FIG. 3, the monitoring method for casino chip management according to an embodiment may include: a step of reading an RFID tag of a subject casino chip (S101); a step of extracting an RFID value from data read at step S101 (S103); a step of comparing the RFID value and a list DB (S105); a step of outputting an alarm (S112); a step of reading a QR code of the subject casino chip (S114); a step of comparing a UID included in the QR code of the subject casino chip and a UID included in the list DB (S116); a step of outputting an alarm (S120); and a step of updating the list DB (S109). For the sake of explanation, the step S112 of outputting the alarm will be referred to as a “first alarm output step,” and the step S120 of outputting the alarm will be referred to as a “second alarm output step.”

The step S101 of reading the RFID tag of the subject casino chip may include a step of reading, by the RFID reader 110, the RFID tag of the subject casino chip in real time.

The step S103 of extracting the RFID value may include a step of detecting a UID, a manufacturer value, and a chip type value from the RFID value of the subject casino chip. At step 103, the information UID may be necessarily detected and at least one of the manufacturer value and the chip type value may be detected as an option.

The step S105 of comparing the RFID value and the list DB may include a step of comparing the RFID value of the subject casino chip and at least one DB of the total list DB, the unstoring list DB, the storing list DB, and the long-term unstoring list DB. The step S105 may include a step of determining whether the subject casino chip is a fake casino chip, is being carried in, is being carried out, or is carried out over a long period, based on the result of comparing the RFID value of the subject casino chip and the list DBs (S107).

The step S109 of updating the list DB may include a step of, when it is determined that the subject casino chip is not a fake chip at step S105 (S107: NO), updating, by the database managing part 106, the list DB already stored.

The step S109 may include a step of, when it is determined that the subject casino chip is carried out, adding the RFID value of the subject casino chip to the unstoring list DB and deleting the RFID value of the subject casino chip from the storing list DB.

The step S109 may include a step of, when it is determined that the subject casino chip is being carried in, adding the RFID value of the subject casino chip to the storing list DB and deleting the RFID value of the subject casino chip from the unstoring list DB.

The step S109 may include a step of, when the RFID value of the subject casino chip is stored in the long-term unstoring list DB, deleting the RFID value of the subject casino chip stored in the long-term unstoring list DB.

The step S109 may include a step of, when carried-out casino chips are not carried in over the first set period, including the casino chips in the long-term unstoring list DB and managing the casino chips.

The step S112 of outputting the alarm may include a step of, when it is determined that the subject casino chip is a fake casino chip (S107: YES), outputting a signal indicating that the subject casino chip is a fake chip in a form recognizable by the manager (an audible or visible form).

The step S114 of reading the QR code of the subject casino chip may include a step of reading, by the QR code reader 170, the QR code printed on the subject casino chip.

The step S116 of comparing the UID included in the QR code of the subject casino chip and the UID included in the list DB may include comparing, by the matching process part 140, the UID included in the QR code of the subject casino chip and the UID included in the list DB. Herein, the list DB may be the total list DB.

The step S116 may include a step of determining whether the UID included in the QR code of the subject casino chip and the UID included in the list DB are equal to each other (S118).

The second alarm output step S120 may include a step of, when the UID included in the QR code of the subject casino chip and the UID included in the list DB are not equal to each other, finally determining that the subject casino chip is a fake casino chip, and outputting an alarm signal indicating that the subject casino chip is A fake chip in a form recognizable by the manager (audible or visible form). For example, the second alarm output step (S120) may include outputting the alarm signal indicating that the subject casino chip is a fake chip when the UID included in the QR code is not included in the total list DB.

Determining whether the subject casino chip is a genuine chip again by using the QR code as described above is to prevent a genuine chip from being determined as a fake chip by a mistake of the manager. For example, when a casino chip is not exactly recorded on the unstoring list DB when being carried out to a player from the currency exchange office, and is carried in, the casino chip may be determined as a fake chip.

While the invention has been shown and described with reference to certain preferred embodiments thereof, it will be understood by those skilled in the art that various changes in form and details may be made therein without departing from the spirit and scope of the invention as defined by the appended claims. Therefore, the scope of the invention is defined not by the detailed description of the invention but by the appended claims, and all differences within the scope will be construed as being included in the present invention.

What is claimed is:

1. A monitoring apparatus for casino chip management, the apparatus comprising:
an RFID reader configured to read an RFID tag of a subject casino chip which is being carried in to or carried out from a currency exchange office;
an information detecting part configured to detect an RFID value of the subject casino chip from data read by the RFID reader;
a storage configured to store list DBs;
a matching process part configured to compare the RFID value detected by the information detecting part and at least one list DB of the list DBs;
a database managing part configured to update the list DBs based on a result of comparison of the matching process part; and
an alarming part,
wherein the list DBs comprise a total list DB comprising RFID values of all casino chips which are distributed and used in the currency office exchange, and an unstoring list DB comprising RFID values of casino chips which are carried out from the currency exchange office,
wherein the RFID value of the subject casino chip comprises a UID of the subject casino chip,
wherein, when the result of comparison of the matching process part indicates that the subject casino chip is a fake chip, the alarming part is configured to output an alarm signal indicating that the subject casino chip is a fake chip,
wherein, when the result of comparison of the matching process part indicates that of the subject casino chip is being carried in, the database managing part is configured to delete the RFID value of the subject casino chip from the unstoring list DB.

2. The monitoring apparatus of claim 1, wherein, when the RFID value of the subject casino chip is not included in the total list DB, the matching process part is configured to determine that the subject casino chip is a fake chip.

3. The monitoring apparatus of claim 2, further comprising a QR code reader configured to read a QR code printed on the subject casino chip,
wherein the QR code comprises a UID of the subject casino chip,
wherein, when the result of comparison of the matching process part indicates that the subject casino chip is a fake chip, the QR code reader is configured to read the QR code printed on the subject casino chip,
wherein the matching process part is configured to compare the UID included in the QR code and the total list DB,
wherein, when the UID included in the QR code is not included in the total list DB, the alarming part is configured to output an alarm signal indicating that the subject casino chip is a fake chip again.

4. The monitoring apparatus of claim 1, wherein the list DB s further comprise a storing list DB which comprises RFID values of casino chips which are carried in to the currency exchange office, and
wherein, when the RFID value of the subject casino chip is included in the storing list DB, the data managing part is configured to delete the RFID value of the subject casino chip from the storing list DB, and to add the RFID value of the subject casino chip to the unstoring list DB.

5. The monitoring apparatus of claim 1, further comprising a counting part configured to count an unstoring period of a casino chip which is carried out from the currency exchange office,
wherein the list DBs further comprise a long-term unstoring list DB comprising RFID values of casino chips which are not carried in over a long period,
wherein, when there is a casino chip that is not carried in to the currency exchange office even when a first set period is elapsed from a time that the casino chip is carried out, from among carried-out casino chips, the counting part is configured to provide an RFID value of the casino chip to the database managing part,
wherein the database managing part is configured to add the RFID value of the casino chip provided by the counting part to the long-term unstoring list DB.

6. The monitoring apparatus of claim 1, further comprising a counting part configured to count an unstoring period of a casino chip which is carried out from the currency exchange office,
wherein the list DBs further comprise a missing list DB,
wherein, when there is a casino chip that is not carried in to the currency exchange office even when a second set period is elapsed from a time that the casino chip is carried out, from among carried-out casino chips, the counting part is configured to provide an RFID value of the casino chip to the database managing part,
wherein the database managing part is configured to add the RFID value of the casino chip provided from the counting part to the missing list DB.

7. A monitoring method for casino chip management, the method comprising:
reading an RFID tag of a subject casino chip;
extracting an RFID value from data read from the RFID tag;
comparing the RFID value and list DBs;
updating the list DBs based on a result of the comparing; and
outputting an alarm indicating that the subject casino chip is a fake chip,
wherein the list DBs comprise a total list DB comprising RFID values of all casino chips which are distributed and used in a currency office exchange, and an unstoring list DB comprising RFID values of casino chips which are carried out from the currency exchange office,
wherein the RFID value of the subject casino chip comprises a UID of the subject casino chip,
wherein the outputting the alarm comprises, when the RFID value of the subject casino chip is not included in the total list DB, outputting the alarm,
wherein the updating the list DBs comprises, when the RFID value of the subject casino chip is included in the unstoring list DB, deleting the RFID value of the subject casino chip from the unstoring list DB.

8. The monitoring method of claim 7, further comprising:
reading a QR code printed on the subject casino chip; and
comparing a UID included in the QR code and the total list DB,
wherein the QR code comprises the UID of the subject casino chip,
wherein, when it is determined that the subject casino chip is a fake chip as the result of comparing the RFID value and the list DBs, the QR code printed on the subject casino chip is read, and the UID included in the QR code and the total list DB are compared,
wherein, when the UID included in the QR code is not included in the total list DB, the alarm is outputted.

9. The monitoring method of claim 7, wherein the list DBs further comprise a storing list DB which comprises RFID values of casino chips which are carried in to the currency exchange office, and
wherein the updating the list DBs comprises, when the RFID value of the subject casino chip is included in the storing list DB, deleting the RFID value of the subject casino chip from the storing list DB, and add the RFID value of the subject casino chip to the unstoring list DB.
